(19) United States
(12) Patent Application Publication
(10) Pub. No.: US 2017/0134732 A1
(43) Pub. Date: May 11, 2017

(54) SYSTEMS AND METHODS FOR DIGITAL MEDIA COMMUNICATION USING SYNTAX PLANES IN HIERARCHICAL TREES

(71) Applicant: BROADCOM CORPORATION, Irvine, CA (US)

(72) Inventor: Peisong Chen, San Diego, CA (US)

(73) Assignee: BROADCOM CORPORATION, Irvine, CA (US)

(21) Appl. No.: 15/344,052

(22) Filed: Nov. 4, 2016

Related U.S. Application Data
(60) Provisional application No. 62/251,423, filed on Nov. 5, 2015.

(51) Int. Cl. H04N 19/159; H04N 19/124; H04N 19/13; H04N 19/105; H04N 19/117; H04N 19/15; H04N 19/51; H04N 19/625; H04N 19/86

(52) U.S. Cl. CPC H04N 19/159; H04N 19/625; H04N 19/124; H04N 19/13; H04N 19/86; H04N 19/117; H04N 19/15; H04N 19/51; H04N 19/105; H04N 19/182

(57) ABSTRACT

Systems and methods are disclosed for video coding using signaling syntax and pixel predictions. The signaling syntax used for encoding and decoding video data is organized into multiple syntax groups based at least in part on the syntax type. The video data is coded plane by plane. The video data in each plane is coded in an order such that processing inter-prediction is prior to intra-prediction.

### RELATED APPLICATION

This application claims the benefit of and priority to U.S. Provisional Patent Application No. 62/251,423, filed on Nov. 5, 2015, the contents of which is incorporated herein by reference in its entirety for all purposes.

### FIELD OF THE DISCLOSURE

This disclosure generally relates to systems and methods for digital video processing including but not limited to signaling syntax and pixel prediction in accordance with such digital video processing.

### BACKGROUND OF THE DISCLOSURE

Communication systems that operate to communicate digital media (e.g., images, video, data, graphical data, etc.) have been under continual development for many years. With respect to such communication systems, a number of digital images are provided to a device for output or display at a frame rate (e.g., frames per second) to effectuate a video signal suitable for output and/or viewing. Within certain communication systems, digital media can be transmitted from a first location to a second location at which such media can be output or displayed. Within many devices that use digital media such as digital video, respective images thereof, being digital in nature, are represented using pixels.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a general block diagram of a communication system according to some embodiments.

FIG. 2 is a general block diagram of a video encoding system according to some embodiments.

FIG. 3A is representation of coding tree block (CTB) quad-tree partitioning according to some embodiments.

FIG. 3B is a representation of a syntax tree corresponding to the CTB quad tree partitioning illustrated in FIG. 3A according to some embodiments.

FIG. 3C is an illustration of a CTB partitioning and encoding corresponding to FIGS. 3A and 3B according to some embodiments.

FIG. 3D is a quad-tree representation of the prediction modes according to some embodiments.

FIG. 4A is a representation of a transform units (TU) partitioning according to some embodiments.

FIG. 4B is a representation of a TU partitioning quad-tree corresponding to the TU partition as shown in FIG. 4A according to some embodiments.

FIG. 5A is an illustration of a 8×8 intra prediction in high efficiency video coding (HEVC) compression according to some embodiments.

FIG. 5B is an illustration of an exemplary intra-prediction of a CTB partitioning surrounded by neighboring inter predicted blocks according to some embodiments.

FIG. 6 is an illustration of omnidirectional spatial predictions according to some embodiments.

FIG. 7A is an illustration of Decoder Side Intra-Prediction (DSIP) algorithm according to some embodiments.

FIG. 7B is a diagram illustrating a line prediction approach for encoding according to some illustrative embodiments.

FIG. 7C is a diagram illustrating a 32×32 inter CU using complementary prediction according to some illustrative embodiments.

FIG. 8 is a flow for encoding syntax elements according to some embodiments.

FIG. 9 is a general block diagram of a video decoding system according to some embodiments.

FIG. 10 is a block diagram illustrating an optimization trellis according to some embodiments

### DETAILED DESCRIPTION OF THE DISCLOSURE

Digital communications systems, including those that operate to communicate digital video, generally attempt to transmit digital data from one location, or subsystem, to another either error free or with an acceptably low error rate in some embodiments. Certain communication systems that use video data operate according to a balance between throughput limitations (e.g., number of bits that may be transmitted) and video and/or image quality of the signal eventually to be output or displayed.

Referring generally to the Figures, various systems and methods are provided that may be used to provide transmit data with an adequate or acceptable video and/or image quality, using a relatively low amount of overhead associated with the communications, using relatively low complexity of the communication devices at respective ends of communication links, etc. according to some embodiments. In some embodiments, the data may be transmitted over a variety of communications channels in a wide variety of communication systems: magnetic media, wired, wireless, fiber, copper, and/or other types of media.

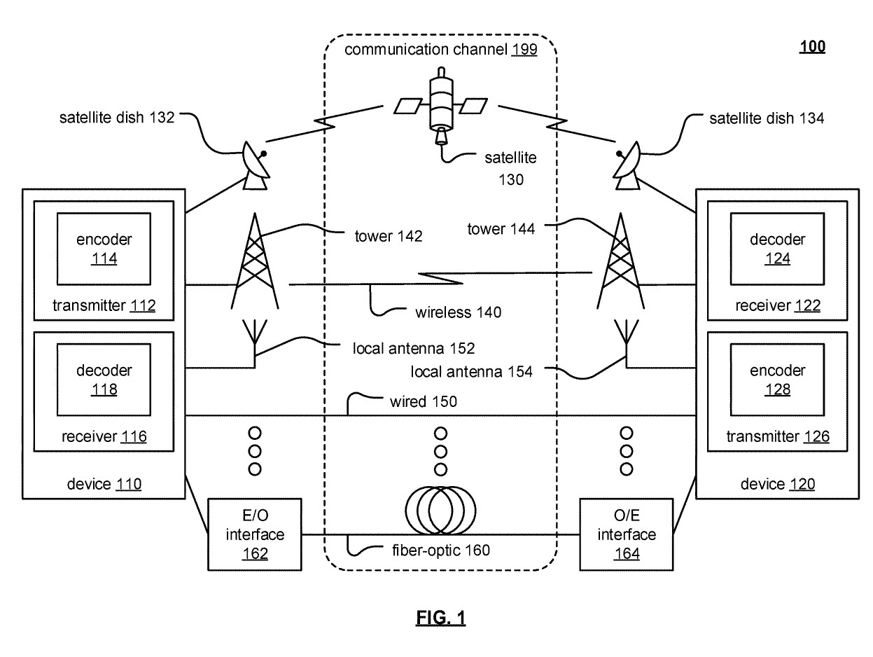

Referring now to FIG. 1, a general block diagram of a communication system 100 is shown according to some illustrative embodiments. The communication system 100 is configured to communicate data between a first location and second location in some embodiments. According to some embodiments, the communication system 100 includes a communication channel 199 that communicatively couples a communication device 110 situated at one end of the communication channel 199 to another communication device 120 at the other end of the communication channel 199. According to some embodiments, the communication device 110 may include a transmitter 112 having an encoder 114 and include a receiver 116 having a decoder 118. According to some embodiments, the communication device 120 may include a transmitter 126 having an encoder 128 and include a receiver 122 having a decoder 124.

In some embodiments, the communication system 100 may be configured to enable a uni-directional communication. Either of the communication devices 110 and 120 may only include a transmitter or a receiver. For example, if the communication device 110 is at a receiving end of the communication system 100, the communication device 110 may include only receiver 116 with the decoder 118 in some embodiments. If the communication device 120 is at a transmitting end of the communication system 100, the communication device 120 may include only transmitter 126 with the encoder 128 in some embodiments. In some embodiments, the communication system 100 may be configured to enable a bi-directional communication and the communication devices 110 and 120 may include both of the transmitters 112, 126 and receivers 116, 122, respectively.

The communication channel 199 may be any type of medium that enables communication between the devices 110 and 120 according to some embodiments. For example, the communication channel 199 may be one or more of a satellite communication channel 130 using satellite dishes 132 and 134, a wireless communication channel 140 using towers 142 and 144 and/or local antennae 152 and 154, a wired communication channel 150, and/or a fiber-optic communication channel 160 using electrical to optical (E/O) interface 162 and optical to electrical (O/E) interface 164. According to some embodiments, the communication channel 199 may be formed by implementing and interfacing together more than one type of media.

The communication devices 110 and/or 120 may be stationary or mobile devices according to some embodiments. For example, either one or both of the communication devices 110 and 120 can be implemented in a fixed location or can be a mobile communication device with capability to associate with and/or communicate with more than one network access point. According to some embodiments, the communication devices 110 and 120 may be any type of mobile devices, such as cellular phones, lap top computers, set top boxes, tablet computers, television sets, servers, monitors, desk top computers, work stations, etc.

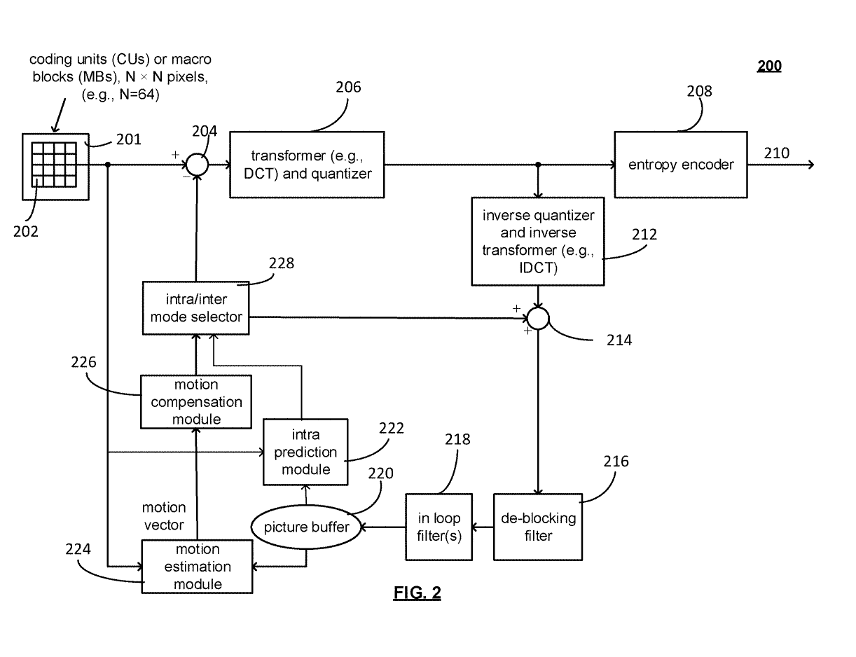

Referring to FIG. 2, a general block diagram of a video encoding system 200 is shown according to some illustrative embodiments. The video encoding system 200 is employed to encode data (e.g., video data) for transmission in the communication system 100 (as shown in FIG. 1) in some embodiments. The video encoding system 200 may be employed in or as encoder 114 and/or encoder 128 in some embodiments. According to some embodiments, the video encoding system 200 may include a partitioner 201, a summer 204, a transformer and quantizer 206, an entropy encoder 208, an inverse transformer and quantizer 212, a summer 214, a de-blocking filer 216, in-loop filters 218, a picture buffer 220, an intra-prediction module 222, a motion estimation module 224, a motion compensation module 226, and an intra/inter mode selector 228. Alternative arrangements and architectures may be employed in the video encoding system 200 for effectuating video encoding in the communication system 100. The video encoding system 200 is configured to produce a compressed output bit stream by carrying out prediction, transform, and encoding operations in some embodiments. The video encoding system 200 may operate in accordance with and is compliant with one or more video coding protocols, standards, and/or recommended practices such as ISO/IEC 14496-10-MPEG-4 Part 10, AVC (Advanced Video Coding), alternatively referred to as ITU-T H.264 or the latest ISO/IEC 23008-2 HEVC (High Efficiency Video Coding), alternatively referred to as ITU-T H.265, in some embodiments.

The video encoding system 200 receives an input video signal 202, which corresponds to raw frame (or picture) image data in some embodiments. The input video signal 202 is partitioned uniformly into coding units or macroblocks by the partitioner 201 which is a software routine operating on a processor or other device for partitioning as explained below. In some embodiments, the size of such coding units may vary and include a number of pixels typically arranged in a square shape. Such coding units may have any desired size such as N×N pixels, where N is an integer. For example, the input video signal 202 may be a frame composed of coding units, and each coding unit may have 64×64 pixels. In some embodiments, the input video signal 202 may include one or more non-square shaped coding units.

The input video signal 202 may undergo compression along a compression pathway according to some embodiments. In some embodiments, the input video signal 202 may be provided via the compression pathway to undergo transform and/or quantization operations via a transformer and quantizer 206 without undergoing inter-prediction or intra-prediction. In some embodiments, the transformer and quantizer 206 may be one of a transformer or a quantizer or both a transformer and a quantizer. The transformer and quantizer 206 may be configured to perform discrete cosine transform (DCT) on the input video signal 202. The transformer and quantizer 206 may include any type and/or form of suitable hardware, software, or combination of hardware and software to operate on the input video signal 202 as explained below in some embodiments.

According to some embodiments, the transformer and quantizer 206 may be configured to compute coefficient values for each of a predetermined number of basis patterns and quantize the coefficient values. The transformer and quantizer 206 may be configured to eliminate coefficient values that are below a predetermined value (e.g., a threshold) by converting less relevant coefficient values to a value of zero in some embodiments. The transformer and quantizer 206 may be also configured to convert significant coefficient values (i.e., above a predetermined value) into values that can be coded more efficiently in some embodiments. For example, the transformer and quantizer 206 may be configured to divide each respective coefficient by an integer value and discarding any remainder.

In some embodiments, the input video signal 202 may undergo intra/inter mode selection by the intra/inter mode selector 228 so that the input video signal 202 may selectively undergo intra and/or inter-prediction processing. The intra/inter mode selector 228 may include any type and/or form of suitable hardware, software, or combination of hardware and software to select between an intra-prediction mode and an inter-prediction mode to process the input video signal 202. According to some embodiments, the intra/inter mode selector 228 may be configured to select inter-prediction mode processing when sufficient pixels are not available within a neighborhood of a coding unit. In some embodiments, the intra/inter mode selector 228 may be configured to select intra-prediction mode processing when sufficient pixels are available within a neighborhood of a coding unit.

The video encoding system 200 may be configured to determine a prediction of the current coding unit based on previously coded data in some embodiments. The previously coded data may be from the current frame (or picture) itself (e.g., such as in accordance with intra-prediction) or from one or more other frames (or pictures) that have already been coded (e.g., such as in accordance with inter-prediction). In some embodiments, the input video signal 202 may undergo a motion estimation operation by the motion estimation module 224 and a motion compensation operation by the motion compensation module 226 for the inter-prediction operation in some embodiments.

According to some embodiments, the motion estimation module 224 and motion compensation module 226 may be configured to perform inter-predictive coding of the received input video signal 202 relative to one or more blocks in one or more reference frames to provide temporal compression. According to some embodiments, the motion estimation module 224 may be configured to compare a set of coding units (e.g., 16×16) from a current frame to a respective buffered counterparts in a picture buffer 220 in one or more previously coded frames (or pictures) within the stream of frames. According to some embodiments, the motion estimation module 224 may further determine the closest matching area and motion vectors based on the comparisons. According to some embodiments, the closest matching area may be used as a prediction reference. According to some embodiments, the motion compensation module 226 may be configured to generate a prediction of the current coding unit based on the motion vectors determined by motion estimation module 224. In some embodiments, the motion estimation module 224 and motion compensation module 226 may be integrated. The video encoding system 200 may be configured to subtract the prediction data from the current coding unit to form a residual using the summer 204 in some embodiments.

In some embodiments, an intra-prediction operation may be selected by the intra/inter mode selector 228. In some embodiments, an intra-prediction module may be configured to employ block sizes of one or more particular sizes (e.g., 16×16, 8×8, or 4×4) to predict a current block from spatially adjacent previously coded pixels within the same frame (or picture). In some embodiments, the video input signal 202 may undergo both inter and intra predictions. For example, the encoding system 200 may employ an intra-prediction operation via an intra-prediction module 222 to the coding units of the input video signal 202 that have encoded units as neighbors. The encoding system 200 may employ an inter-prediction operation to the coding units that do not have all the neighbors as encoded units in some embodiments.

In some embodiments, a set of residuals determined by inter and/or intra-prediction operations may undergo transform operations via the transformer and quantizer 206 (e.g., in accordance with discrete cosine transform (DCT)). According to some embodiments, the transform operations may output a group of coefficients such that each respective coefficient corresponds to a respective weighting value of one or more basis functions associated with a transform. According to some embodiments, after undergoing transformation, a block of transform coefficients may be quantized. For example, each respective coefficient may be divided by an integer value, referred to as quantization step size and any associated remainder may be discarded, or they may be multiplied by an integer value. The quantization operation is generally inherently lossy, and it can reduce the precision of the transform coefficients according to a quantization parameter (QP). In some embodiments, many of the coefficients associated with a given transform block may be zero, and only some non-zero coefficients may remain. In some embodiments, a relatively high QP setting may be operative to result in a greater proportion of zero-valued coefficients and smaller magnitudes of non-zero coefficients, resulting in relatively high compression (e.g., relatively lower coded bit rate) at the expense of relatively poorly decoded image quality; a relatively low QP setting is operative to allow more non-zero coefficients to remain after quantization and larger magnitudes of non-zero coefficients, resulting in relatively lower compression (e.g., relatively higher coded bit rate) with relatively better decoded image quality.

In some embodiments, the encoding system 200 may include a feedback path which enables the output of the transformer and quantizer 206 to undergo inverse quantization and inverse transform operations via an inverse transformer and quantizer 212. The inverse transformer and quantizer 212 may be configured to apply an inverse transform (e.g., an inverse DCT, an inverse integer transform, or a conceptually similar inverse transform process) to the transform coefficients in order to produce residual blocks in the pixel domain in some embodiments. The inverse transformer and quantizer 212 may be one of an inverse transformer or an inverse quantizer or both an inverse transformer or an inverse quantizer in some embodiments.

According to some embodiments, the output residuals from the inverse transformer and quantizer 212 may be combined with predictions generated by the inter prediction and/or intra prediction operation via the summer 214. According to some embodiments, the combined residuals and prediction may be provided to a de-blocking filter 216. The de-blocking filter 216 may be configured to filter block boundaries to remove blockiness artifacts from reconstructed video signal in some embodiments. The output from the de-blocking filter 216 may be provided to one or more in-loop filters 218 (e.g., implemented in accordance with adaptive loop filter (ALF), sample adaptive offset (SAO) filter, and/or any other filter type) implemented to process the output from the inverse transform block in some embodiments. For example, in some embodiments, an ALF may be applied to the decoded picture before it is stored in the picture buffer 220 (again, sometimes alternatively referred to as a DPB, digital picture buffer). In some embodiments, the ALF may be implemented to reduce coding noise of the decoded picture, and the filtering thereof may be selectively applied on a slice-by-slice basis, respectively, for luminance and chrominance, whether or not the ALF is applied either at slice level or at block level. In some embodiments, two-dimensional (2-D) finite impulse response (FIR) filtering may be used in application of the ALF. According to some embodiments, the coefficients of the filters may be designed slice by slice at the encoding system 200, and such information may be then signaled to the decoder (e.g., signaled from a transmitter communication device including a video encoder to a receiver communication device including a video decoder. According to some embodiments, the output of the in loop filters 218 may be stored in the picture buffer 220. The data stored in the picture buffer 220 may be used for further inter and/or intra-predictions in some embodiments.

According to some embodiments, the video encoding system 200 may be configured to produce a number of values that are encoded to form the compressed bit stream 210. Examples of such values include the quantized transform coefficients, information to be employed by a decoder to re-create the appropriate intra or inter-prediction, information regarding the structure of the compressed data and compression tools employed during encoding, information regarding a complete video sequence, etc. In some embodiments, such values and/or parameters (also known as syntax elements) undergo encoding within the entropy encoder 208 operating in accordance with context-adaptive binary arithmetic coding (CABAC), context-adaptive variable-length coding (CAVLC), or some other entropy coding schemes, to produce an output bit stream that may be stored, transmitted, etc.

Various modules and components described in FIG. 2 are implemented as a software routine operating on a computer processor, application specific circuit, digital signal processor, or other circuit in some embodiments. According to some embodiments, the picture buffer 220 may be any type of memory or storage unit.

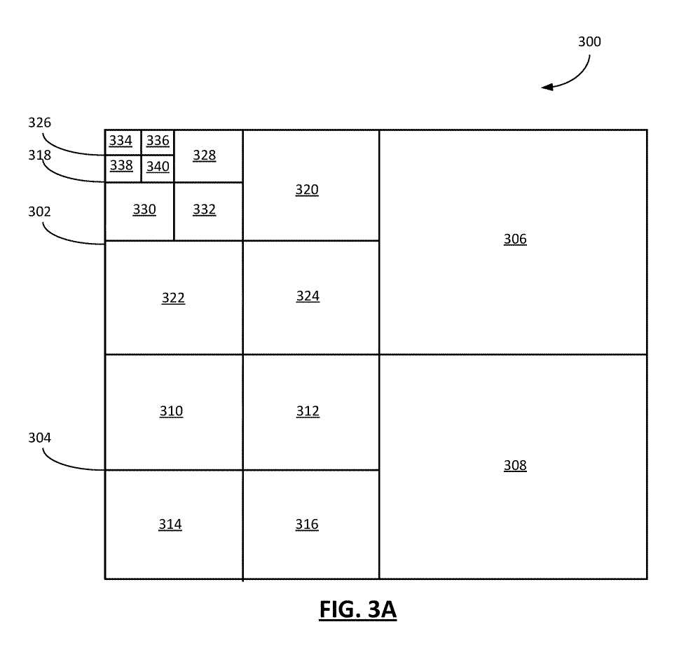

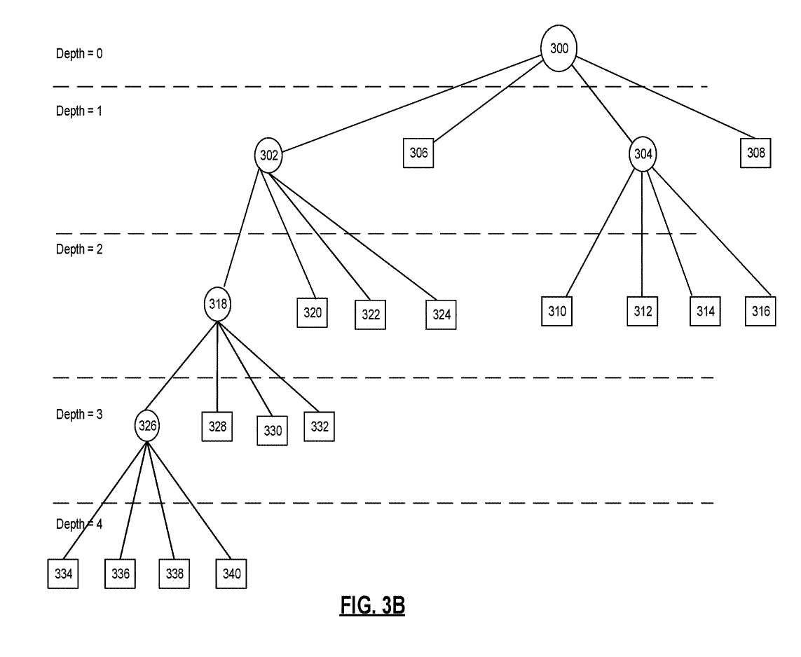

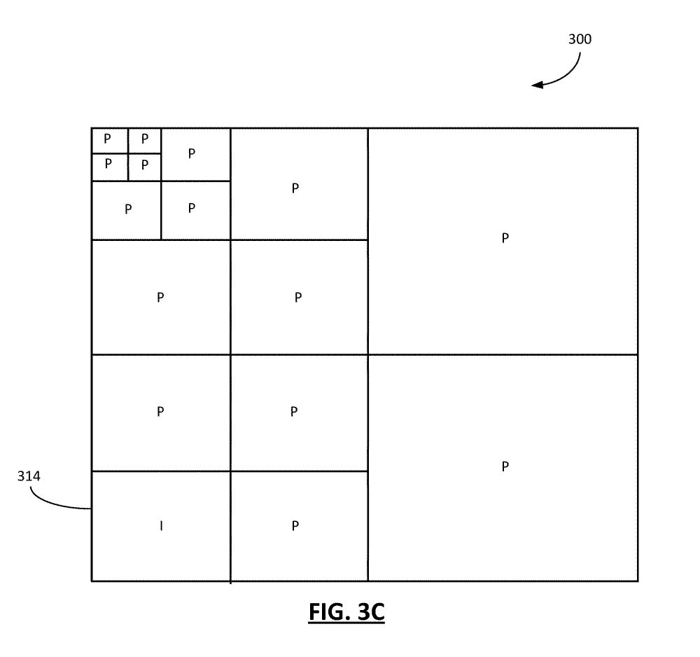

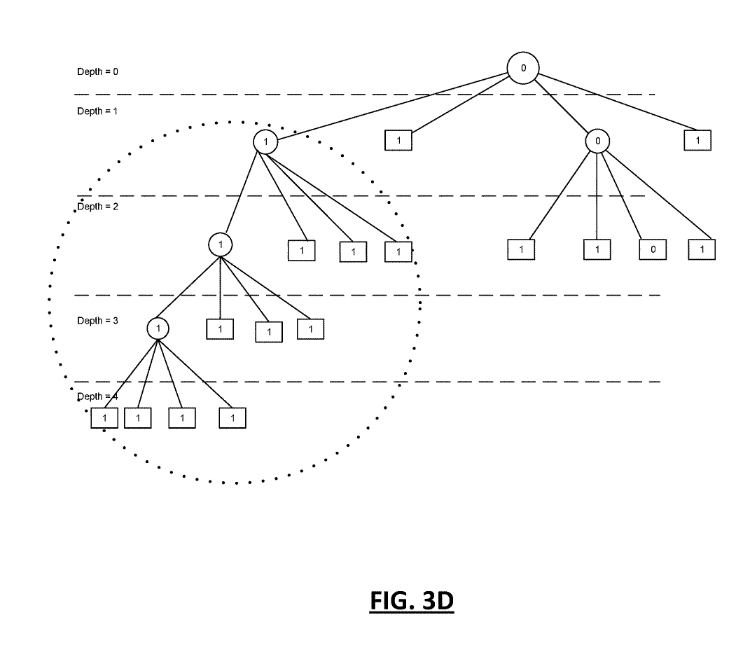

FIG. 3A is an illustration of coding tree block (CTB) quad-tree partitioning according to some embodiments. The partitioner 201 of the video encoding system 200 (FIG. 2) may perform partitioning operations in some embodiments. A picture used as input to an encoding system (e.g., input video signal 202) and may be partitioned uniformly into basic processing units (e.g., macroblocks or CTBs) before inputting to the summer 204, the intra prediction module 222, and the motion estimation module 224 by the partitioner 201 in some embodiments. In AVC/H.264, such a basic processing unit is called “macroblock”, while in HEVC/H.265 it is called “coding tree block” (CTB). According to some embodiments, the CTB size may be up to 64×64. Starting from a CTB, the encoding system 200 may determine whether or not to split the CTB into coding units (CU) and determine whether or not further split each coding units to smaller coding units.

As shown in FIG. 3A, a CTB 300 is evenly split into four coding units 302, 304, 306, and 308. The encoding system 200 is configured to determine whether or not to split each of the CUs 302, 304, 306, and 308. The CUs 306 and 308 are determined to be not split. The CU 302 is determined to be evenly split into four CUs 318, 320, 322, and 324. The CU 304 is determined to be evenly split into four CUs 310, 312, 314, and 316. The CUs 320, 322, 324, 310, 312, 314, and 316 are further determined to be not split. The CU 318 is determined to be evenly split into four CUs 326, 328, 330, and 332. The CUs 328, 330, and 332 are determined to be not split. The CU 326 is determined to be evenly split into four CUs 334, 336, 338, and 340. According to some embodiments, the CUs 334, 336, 338, and 340 may be coding units with desired size. According to some embodiments, this partitioning operation can be repeated recursively, splitting each of those smaller CUs 334 (or not) until reaching a desired CU size. FIG. 3A shows an example of a 64×64 CTB with four levels of quad-tree partition according to an illustrative embodiment.

In terms of luma pixels, each CU may be 64×64, 32×32, 16×16, or 8×8 pixels according to some embodiments. Each CU may consist of one or more non-overlapping prediction units (PU) in some embodiments. Prediction units may be used to define the motion vectors used for motion compensation or the intra-modes used for spatial prediction in some embodiments.

FIG. 3B shows a syntax tree corresponding to the CTB partitioning in FIG. 3A according to some illustrative embodiments. According to some embodiments, each circle or rectangle as shown in FIG. 3B represents a CU. Each CU may be associated with a split flag indicating whether or not to split the coding unit. For example, a split flag may be set as 1 indicating split and 0 indicating non-split. The partitioner 201 of the encoding system 200 may perform the CTB partitioning operations in some embodiments. In HEVC, the syntax within the CTB 300 may be organized in a quad-tree structure according to some embodiments. According to some embodiments, each syntax element of the syntax tree may represent a CU. According to some embodiments, the HEVC syntax may be designed in such a way that the tree traversal may be a depth-first approach such that one goes down first (first child unit 302, then its grandchild unit 318 before a second child unit 306). Each syntax element may be related to at least one of a prediction mode, a partitioning mode, intra-prediction directions for intra-prediction mode, motion information for inter-prediction mode, quantization parameters, coded block flags (CBF) and residual coefficients.

According to some embodiments, instead of traversing the syntax elements in the depth-first approach, all syntax elements in a CTB 300 may be organized into syntax planes. Each plane may group at least one type of syntax element across the whole CTB 300 according to some embodiments. When an input video signal (i.e., current frame or picture) undergoes entropy coding, all CTB syntax elements may be encoded plane by plane in some embodiments.

In some embodiments, various syntax planes may be created by grouping the corresponding types of syntax elements across the CTB 300. According to some embodiments, the various syntax planes may include split flag plane, prediction mode plane, partitioning mode plane, reference index plane, motion vector plane, spatial prediction direction plane, quantization parameter plane, coded block flag plane, and coefficient plane. Each syntax plane includes at least one type of syntax elements. For example, as shown in FIG. 3B, CUs 300, 302, 318, 326, and 304 may be grouped into a syntax plane based on the partitioning mode. According to some embodiments, split flags associated with all CUs may be grouped together as a syntax plane. By paring the split flag syntax plane only, a compatible decoder may have a full picture about how a CTB is partitioned without paring other types of syntax elements.

In some embodiments, the CTB syntax elements may be encoded plane by plane and the information therefrom may be used to derive better context model for the following syntax planes. For example, the CTB split flag plane may provide some indication on the degree of difficulty to compress the current CTB. If the number of quad-tree split levels is large (i.e., many depths) and/or many CUs are determined to be split into smaller CUs, a different context model from CTBs with less quad-tree split levels and/or more coding units with larger block sizes may be used. There may be several ways to estimate the difficulty to compress, alternatively referred to as activity measure according to some embodiments. After each syntax plane is coded, the activity measure may be updated by feeding new available information. The updated activity measure may be used for coding the following syntax planes. In this way, a cross-syntax dependency may be effectually exploited in some embodiments.

In some embodiments, the CTB syntax elements may be transmitted plane by plane. For example, the output syntax elements from an encoding system may be transmitted to a decoding system by transmitting a partitioning mode plane including all the partitioning information of all the coding units in the CTB, then transmitting a prediction mode plane including all the information regarding prediction mode selection of all the coding units in the CTB.

In some embodiments, this syntax plane approach may also be extended to sub-pictures such as tiles, slices, or a whole picture. In this case, each syntax plane may include the corresponding syntax element(s) of all CTBs in a sub-picture. According to some embodiments, the encoding system may be configured to group the same syntax across the whole syntax plane, instead of encoding each syntax element one-by-one. The grouping of syntax into syntax plane improves coding efficiency.

FIG. 3C is an illustration of a CTB partitioning and encoding corresponding to FIGS. 3A and 3B according to some illustrative embodiments. Within each block, “I” indicates prediction mode is an intra-prediction mode, and “P” indicates prediction mode is an inter-prediction mode. The CU 314 is indicated as being associated with an intra-prediction mode. All other CUs are indicated as being associated with inter-prediction mode.

FIG. 3D is a quad-tree representation of the prediction modes according to some illustrative embodiments. As shown in FIG. 3D, the circle indicates a unit that is determined with further partition and rectangle indicates a unit that is determined without further partition. Each circle or rectangle has a number inside, which indicates whether the tree branch starting from this unit uses only inter prediction. “1” means the answer is true while “0” means the answer is false. For each branch starting from a unit with “1” inside, all the child units split from the unit are grouped together for encoding. So that there is no need to traverse each child under that branch, which reduces the signaling significantly. As shown in FIG. 3D, the units within the branch surrounded by a dotted-line are grouped together. Only one-bit flag is enough to indicate all units within the branch use inter mode. For example, when the top parent unit within the circle is indicated as 1, all units split from the top unit are automatically set as 1.

In some embodiments, instead of traversing the whole quad-tree, only the root unit's status may be signaled. If the root unit's number is 1, it means the whole CTB under the root unit uses inter prediction. If the root unit's number is 0, the status of each leaf unit under the root unit may be signaled individually and all intermediate units between the root to the leaves maybe bypassed. In a case where all CUs in a CTB use inter prediction, the root node's number is 1 and that is the only information needed to be signaled for the prediction modes of the whole CTB.

In some embodiments, the same idea may be applied to other syntax planes such as coded block flag (CBF) plane. In the traditional approach without using syntax plane, residual quad-trees start from leaf CU units and they do not cross CU boundaries. Using the syntax plane approach, residual quad-trees can start from any unit of the CTB, including the root unit.

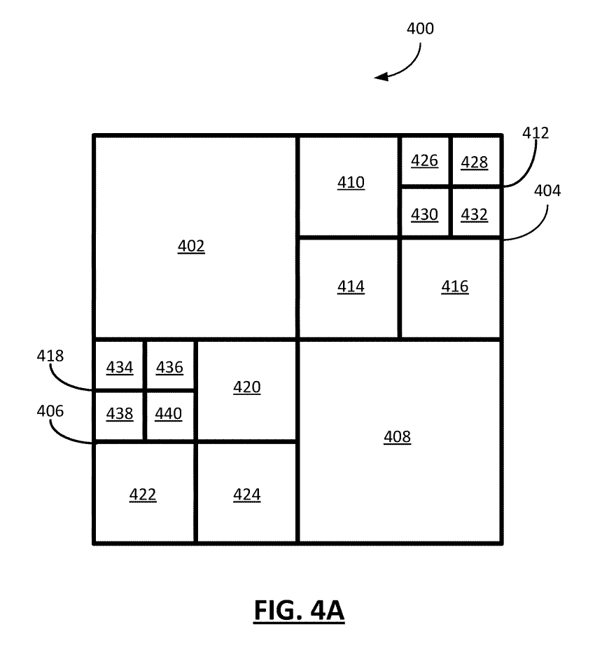

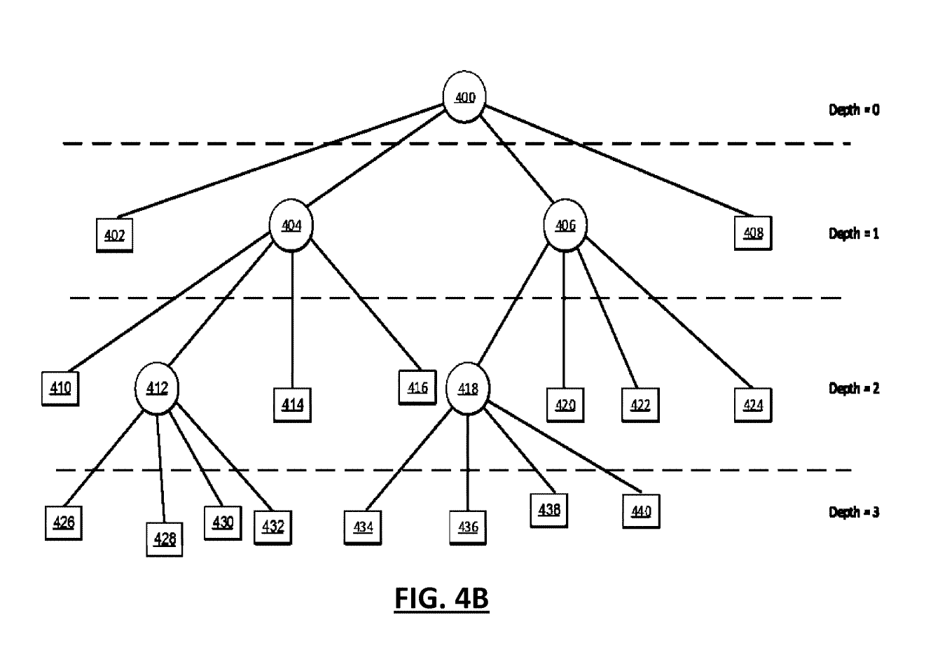

Referring to FIG. 4A, a transform units (TU) partitioning is shown according to some illustrative embodiments. According to some embodiments, each CU may consist of one or more non-overlapping transform units (TU). These transform units define the block size used for residual transforms. Similar to CUs, transform units are represented using a quad-tree hierarchy. Sometimes this TU coding structure is also called the residual quad-tree (RQT).

According to some embodiments, a TU 400 may be determined to be split into TUs 402, 404, 406, and 408. Each TU may further undergo determination of whether to be split or not. The TUs 402 and 408 are determined to be not split. The TU 404 is determined to be split into 410, 412, 414, and 416. The TU 406 is determined to be split into 418, 420, 422, and 424. The TU 412 is further determined to be split into 426, 428, 430, and 432. The TU 418 is further determined to be split into 434, 436, 438, and 440. According to some embodiments, the TUs 426, 428, 430, 432, 434, 436, 438, and 440 may reach a desired TU size, so that the partitioning is stopped. According to some embodiments, the partitioning may be repeated recursively until a smaller desired size is reached.

Referring to FIG. 4B, a TU partitioning quad-tree corresponding to the TU partition is shown according to some illustrative embodiments. Each square or circle in the FIG. 4B represents a TU. According to some embodiments, each TU may be associated with a split flag. For example, the square may have a split flag 0 indicating non-split, and the circle may have split flag 1 indicating split. The TU 400 is split into four TUs 402, 404, 406, and 408, among which TUs 402 and 408 are determined to be not split. The TU 404 is determined to be further split into four TUs 410, 412, 414, and 416. The TU 406 is determined to be further split into four TUs 418, 420, 422, and 424. According to some embodiments, the partitioning may be stopped at a desired TU size, for example, at TUs 410, 414, 416, 420, 422, and 424. According to some embodiments, the partitioning may be further repeated on one or more selected TUs, such as TUs 412 and 418. The selected TUs 412 and 418 are further split into smaller TUs, such as 426, 428, 430, 432, 434, 436, 438, and 440.

According to some embodiments, in regards to intra-prediction, the TU may define an intra-prediction block size, not the prediction unit (PU). According to some embodiments, the PU may specify an intra-prediction mode for all blocks within the PU. According to some embodiments, the actual intra-prediction block size within each PU may be defined by the transform residual quad-tree. So, for example a 16×16 PU would not necessarily use a single 16×16 intra predicted block. This PU might contain several 8×8 and 4×4 transform blocks. In this case, the intra prediction process is performed sequentially for each of these smaller transform blocks within the PU, not the entire 16×16 PU.

According to some embodiments, for the inter coded CUs, each prediction unit (PU) and transform unit (TU) can be defined independently. According to some embodiments, the TU size may be larger than the PU size. For example, two 16×8 motion vectors may be used with a single 16×16 transform block.

According to some embodiments, Luma coded block flags (CBF) may be coded at each TU in the TU partitioning quad-tree. These CBFs may indicate whether the luma transform unit at that position in the tree has any non-zero coefficients or not in some embodiments. When the CBF is set as 0, the residual coefficient syntax is skipped for the corresponding TU.

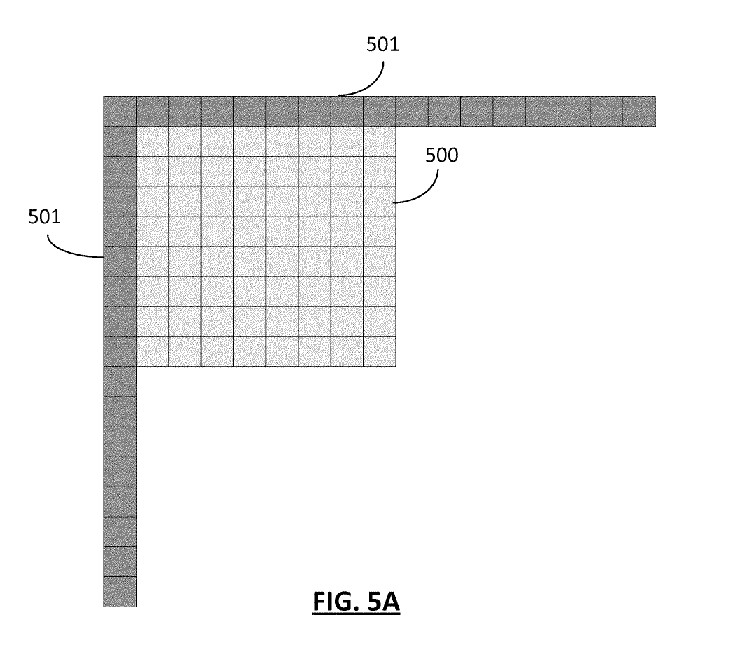

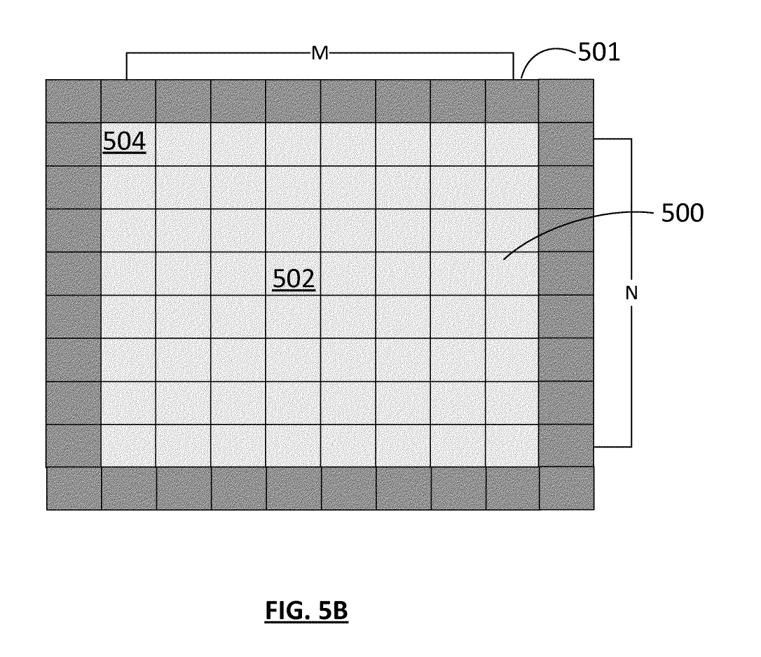

FIG. 5A is an illustration of an 8×8 intra-coded block 500 in HEVC. The neighboring coding blocks 501 of the intra-coded block 500 used for intra-prediction are represented with shade. Depending on the size and location of the block, some blocks may not be available. The block's right and bottom immediate neighbors are not used for intra-prediction because they are not available. In some embodiments, it is advantageous to encode all inter coded blocks in a CTB first and then encode the remaining intra coded blocks 500 in the CTB. This sequential inter-intra processing order can remove the original limitation in some embodiments. This may expand the neighborhood and provide better intra-prediction in some embodiments. For example, if an intra coded block 500 is surrounded by inter coded block 501, all reconstructed neighboring blocks along the intra block boundary may be available for intra-prediction. By reconstructing inter blocks before intra blocks in a CTB, all the neighboring blocks may be available on the block's right and/or bottom boundary as shown in FIG. 5B in some embodiments. According to embodiments, at a slice, picture, and/or sequence header, a syntax element may be introduced to indicate whether this sequential inter-intra processing is enabled.

FIG. 5B illustrates an exemplary intra-prediction of an intra-coded block 500 surrounded by neighboring inter predicted blocks 501. A coding unit 502 (i.e., p[x, y]) within the intra-coded block 500 represents a pixel in the current picture. The intra-coded block 500 has a size of M×N. The top left pixel 504 of the current intra-coded block 500 is p[0,0]. Using this notation, p[M, y] are neighboring pixels along the right boundary, and p[x, N] are neighboring pixels along the bottom boundary. The block pred₀[x,y] represents the predicted block by using traditional spatial prediction. In some embodiments, bipredictive intra-prediction is represented by:

pred[M−1,y]=w·pred₀[M−1,y]+(1−w)·p[M,y]

pred[x,N−1]=w·pred₀[x,N−1]+(1−w)·p[x,N]

where w is a weighting parameter in [0,1]. The variable w can use a default value such as 0.5 or it can be calculated based on rate-distortion optimization and signaled in a picture header, in a slice header or at a block level. The above weighted averaging may not be limited to the right and bottom boundary pixels. It can be applied to the interior pixels also, where the weighting parameters are pixel location dependent. In some embodiments, intra prediction of a coding unit is represented by:

pred[x,y]=w_{0,x,y}·pred₀[x,y]+w_{1,x,y}·p[M,y]+w_{2,x,y}·p[x,N]

where w_{0,x,y}, w_{1,x,y}, w_{2,x,y} are location dependent weighting parameters, and can be represented by:

$${w}_{0 , x , y} = \frac{1}{2} ( \frac{M - x}{M + 1} + \frac{N - y}{N + 1} ) , \\ {w}_{1 , x , y} = \frac{1}{2} \frac{x + 1}{M + 1} , \\ {w}_{2 , x , y} = \frac{1}{2} \frac{y + 1}{N + 1} .$$

It is advantageous to combine the syntax plane structure and the sequential inter-intra processing order for intra predicted blocks and inter predicted block so that the neighborhood of an intra block is known in advance and intra-prediction direction may cover 360 degree in some embodiments. For example, after parsing the syntax plane corresponding to prediction modes in a CTB, the decoder may determine the locations of intra blocks and inter blocks before paring any syntax related to spatial prediction direction.

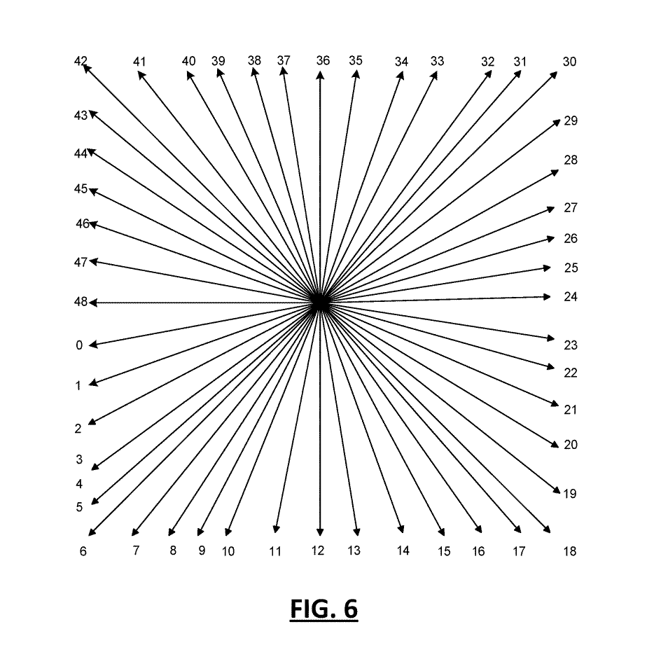

The number of possible intra-prediction directions may adapt to the neighborhood situation in some embodiments. If an intra block's all neighboring pixels are available, spatial predictions may be omnidirectional as shown in FIG. 6. According to some embodiments, different operations may be used to find the best prediction direction for an intra block based on its neighborhood situation. In some embodiments, a two-pass encoding operation may be used to find the best prediction direction for the intra block. During the first pass, CUs in a CTB may be traversed in a depth-first approach. An encoding system may be configured to find the best partitioning mode and prediction mode for each CU in the CTB in some embodiments. Each CU may be determined as either an inter block or an intra block. In the first pass, the neighborhood of an intra block may be limited by the traverse order in some embodiments. Some neighborhood pixels such as the right or bottom neighbors may not be available in some embodiments. During the second pass, for the intra blocks determined during the first pass, the encoding system may be configured to search for the best intra-prediction direction based on the updated neighborhood status in some embodiments. For example, if an intra CU is surrounded by inter CUs, intra prediction direction may be searched in 360 degree.

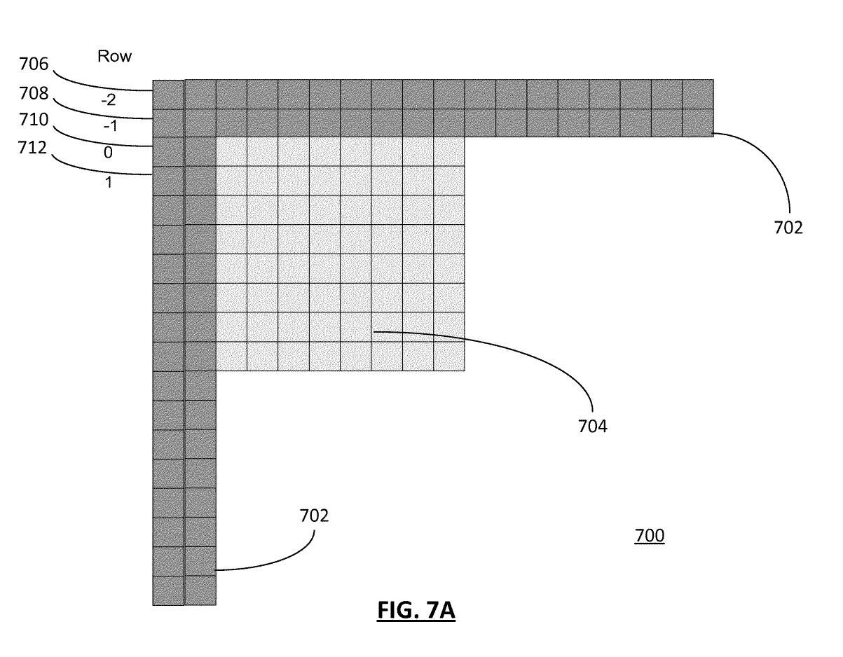

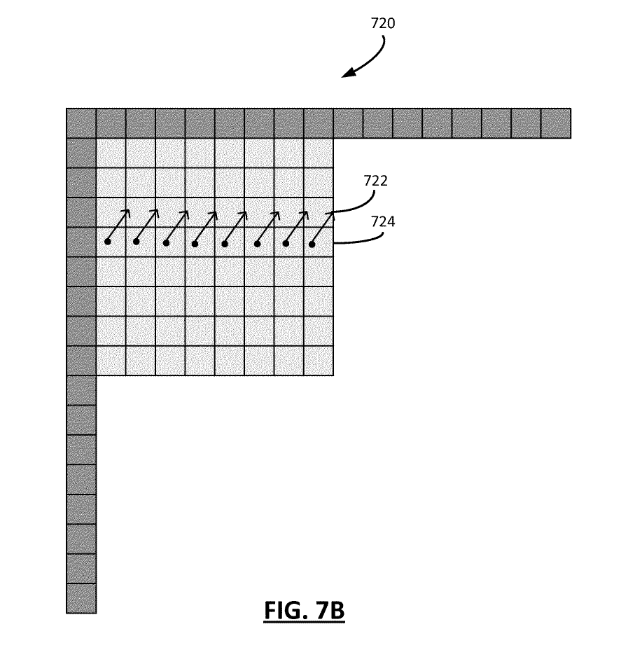

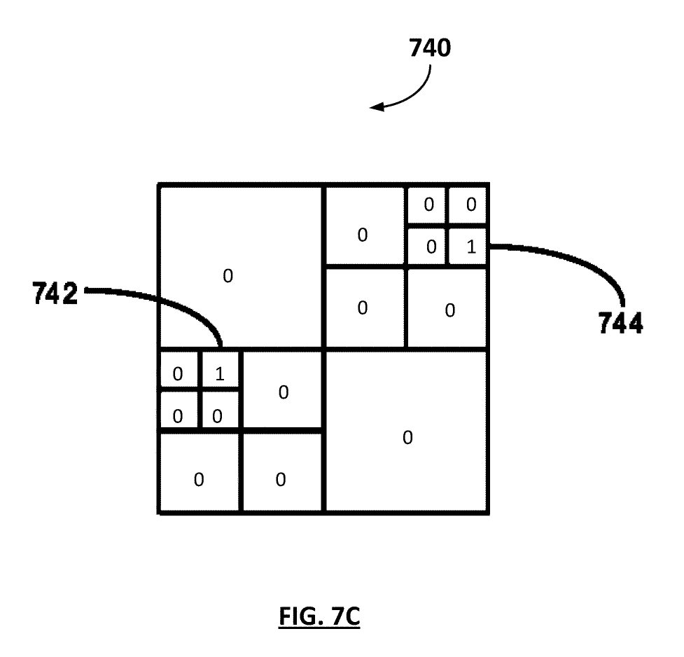

To further enhance intra-prediction performance, an intra-prediction algorithm called Decoder Side Intra-Prediction (DSIP) is illustrated in FIG. 7. The DSIP algorithm includes two processing modes. According to some embodiments, in the first mode, an intra-coded block 704 may be processed row by row and in the second mode, the intra-coded block 704 may be processed column by column. According to some embodiments, the operations in both modes may be similar except the scan order is different. The algorithm using the first mode (row by row scan) is described below as an example.

The shaded pixels shown in FIG. 7 indicate the reconstructed neighboring pixels 702. Depending on the size and location of the block, some pixels may not be available. For example, the right and bottom neighbors are not available as shown in FIG. 7. When the two rows 706, 708 (i.e., row −2 and row −1) above the current intra-coded block 704 are accessible, the spatial prediction direction from row −2 to row −1 may be estimated. This prediction direction may be used as the prediction direction from row −1 to row 710 (row 0) according to some embodiments. The residual of row 0 may be transformed by a 1-D transform, followed by quantization and inverse quantization in some embodiments. The reconstructed row 0 may be used to estimate the prediction direction from row −1 to row 0 and that is used to predict row 712 (row 1) from row 0. Both the encoder and the decoder may follow the same process to derive the intra prediction direction according to some embodiments. In this way, each row in the intra-coded block 704 may be predicted by estimating a prediction direction using the previous two rows.

In some embodiments, to keep the line buffer size small, only one row may be accessible. If there is only one row above the current block, vertical prediction may be used initially as the prediction direction from row −1 to row 0 in some embodiment.

This row-by-row or column-by-column line prediction approach can be applied to traditional intra angular prediction as well. In the traditional intra prediction, each intra-block is predicted from previously decoded pixels in neighboring blocks and predicted pixels for the current block are generated by using those decoded pixels in neighboring blocks instead of pixels from the current block.

FIG. 7B is a diagram illustrating line prediction approach for encoding according to some illustrative embodiments. In the traditional intra-prediction approach, each coding unit at each row of the block use reconstructed pixels from the neighboring blocks for prediction. In the line prediction approach, a reconstructed previous row (column) is used to predict the current row (column). Because the row (column) used for prediction are the closest available neighboring pixels of the current row (column), more accurate prediction can be achieved. As shown in FIG. 7B, a prediction of the fourth row 724 of a block 720 is conducted using the reconstructed pixels from the third row 722. The line prediction approach provides more accurate prediction results.

After the line prediction, 1-D transform may be applied to the residual of each line according to some embodiments. Coefficients for the 1-D transform of each line may be first quantized and then reconstructed for predicting the next line according to some embodiments. The quantized coefficients may be further coded by an entropy coder. According to some embodiments, the coefficients for the coding units at each line may be treated as a coefficient group (CG). For example, for a 16×16 transform block, there are 16 CGs. Because of the dependency between two neighboring lines, the quality of the previous line may impact the prediction of the current coded line according to some embodiments. It will be beneficial to jointly optimize the quantization of CGs of a transform block to achieve a desirable balance of rate and distortion. The optimization problem is to find the minimal Lagrangian cost function J(λ) defined as

$$J ( λ ) = {\sum }_{i = 1}^{N} D ( {C}_{i , Q} ) + λ R ( {C}_{i , Q} )$$

where D(C_{i,Q}) is the distortion of the CG Ci when quantized to quality level Q, λ is a Lagrange multiplier, and R(Ci,Q) is a bit cost to encode C_{i,Q}. The distortion metric may be a mean-squared-error (MSE) distortion, an activity-weighted MSE, or another distortion metric according to some embodiments. The quality level may be a quantization parameter (QP) which is widely used in H.264 and H.265 standards according to some embodiments. According to some embodiments, a truncation may be applied to the coefficients. According to some other embodiments, the quality level may correspond to coefficient truncation positions. For example, a 1×16 1-D transform may generate 16 coefficients from low frequency to high frequency. For example, a coefficient may be selected as a truncation position, so that a truncation may be applied to set the truncation coefficient and all the coefficients that are higher than the truncation coefficient to zero. According to some embodiments, truncating at different coefficients corresponds to different quality levels and therefore different tradeoff between rate and distortion.

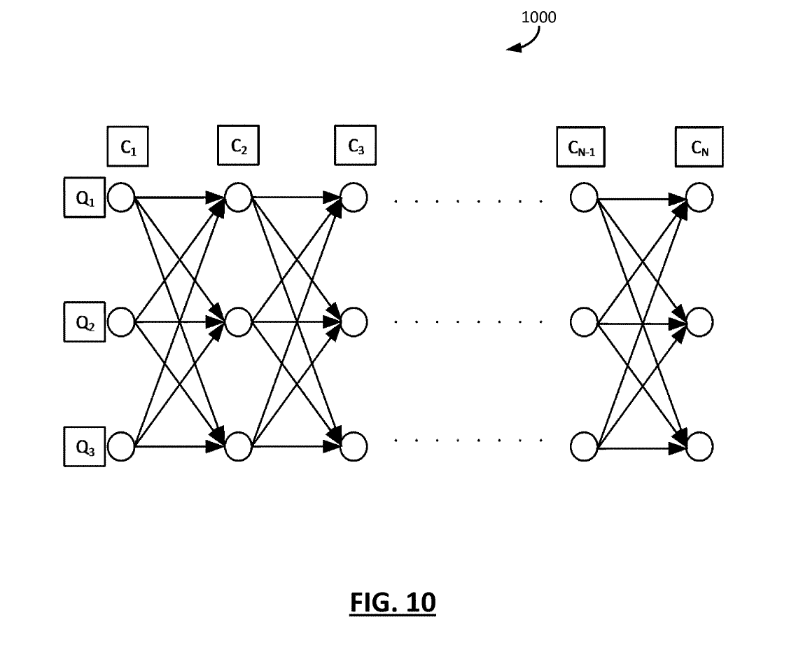

Referring to FIG. 10, a block diagram illustrating an optimization trellis 1000 is shown according to some embodiments. According to some embodiments, rate and distortion optimized quantization of CGs may be implemented using a trellis quantization as illustrated in FIG. 10 to minimize the cost function. According to some embodiments, the optimization trellis 1000 may have N stages, such as stages C₁, C₂, . . . C_{N} as shown in FIG. 10. According to some embodiments, each stage corresponding to an individual CG of a block. According to some embodiments, each of the N stages may have one or more states, and each state may correspond with a candidate quality level. For example, as shown in FIG. 10, for each stage C, there are three states, such as states Q₁, Q₂, and Q₃.

According to some embodiments, a path through the trellis may represent a sequence of quantization decision on all the CGs in a block. According to some embodiments, various dynamic programming algorithms may be used to find the surviving path through the trellis, such as the Viterbi's algorithm. In each stage of the trellis, cost (e.g., according to the Lagrangian cost function) may be computed for each of the candidate quality level based on each surviving path up to the current CG. For the CGs in the current stage and the past stages along each surviving path, coding cost can be calculated.

At the second stage of the trellis, for example, which corresponds with C₂, coding cost for each combination of candidate quality levels associated with CG C₁ and C₂ may be calculated in some embodiments. According to some embodiments, three coding costs may be calculated for each quality level of stage C₂, such as Q₁C₂, Q₂C₂, and Q₃C₂. For example, for Q₁C₂ (i.e., candidate quality level 1 associated with CG C₂), a first coding cost is calculated using quality level 1 for C₁, a second coding cost is calculated using quality level 2 for C₁, a third coding cost is calculated using quality level 3 for C₁. The path having the lowest coding cost is selected as the surviving path for Q₁C₂. After selecting the surviving paths for each quality level of CG C₂ (e.g., Q₁C₂, Q₂C₂, and Q₃C₂), the same process is applied to the next CG, e.g., C₃. The selection of surviving paths of quality levels may be conducted for each CG according to some embodiments. A surviving path through the whole trellis may be provided by connecting the selected surviving paths for each CG according to some embodiments. The surviving path represents a sequence of quantization or quality level selection decision on all the CGs in a block.

To efficiently represent all CGs in a block, for each CG, the entropy coder may use a one-bit flag CG_all_zero to indicate whether the CG's coefficients are all zero or not according to some embodiments. For example, the entropy coder may scan CGs backwardly, starting from the last CG corresponding to the last row/column of the block. After encountering a CG_all_zero=0 (false), the entropy coder may code another one-bit flag Last_nonzero_CG to indicate whether this CG is the last CG having nonzero coefficient. If Last_nonzero_CG is equal to 1(true), the one-bit flag of the remaining CGs may be inferred to be 1(true) and the CG_all_zero flags may be not sent to the remaining CGs according to some embodiments. If Last_nonzero_CG is equal to 0 (false), there is at least one CG having a one-bit flag CG_all_zero that is equal to 0 (false) according to some embodiments.

According to some embodiment, instead of sending Last_nonzero_CG flags, the entropy coder may signal the location (row/column index) of the last CG that has nonzero coefficients in the previously mentioned scan order before signaling any CG_all_zero. According to some embodiments, the entropy code may scan CGs forwardly starting from the first CG corresponding to the first row/column.

According to embodiments, during the line prediction, for some pixels, their reference pixels in the previous line used for prediction may be located outside the previous coded row. There are two ways to solve this problem. One is padding the outside reference pixels with the closest reference pixels within the previous row. The other one is predicting those pixels by using the decoded pixels in the neighboring blocks (i.e., intra prediction).

FIG. 7C is a diagram illustrating a 32×32 inter CU 740 using complementary prediction according to some illustrative embodiments. According to some embodiments, in RQT, when a TU has a coded block flag set as “1”, a complementary prediction may be applied to the TU. According to some embodiments, the complementary prediction may be used to replace the original prediction or it may be used to work jointly with the original prediction.

The inter CU 740 is partitioned into multiple TUs. Each TU has a CBF indicating whether the TU is selected for complementary prediction. When the CBF equals to 1, the corresponding TU is selected for complementary prediction. When the CBF equals to 0, the corresponding TU is not selected for complementary prediction. According to some embodiments, the complementary prediction may be either inter prediction or intra prediction. If the complementary prediction works jointly with the original prediction, the weight sum of the original prediction and the complementary prediction will be the final prediction for the TU. If the complementary prediction is inter prediction, a different motion vector from the original motion vector may be used. The original motion vector may be used to predict the complementary motion vector according to some embodiments.

In the context of complementary prediction, the semantics of CBF is expanded. When the CBF is 0, it indicates the corresponding TU is not selected for complementary prediction and all coefficients within the corresponding TU are zero. When CBF is 1, it indicates the corresponding TU is selected for complementary prediction, but does not indicate whether the complementary is applied or not. A first separate flag may be introduced to indicate whether complementary prediction is used or not according to some embodiments. If the first separate flag is 0, it indicates complementary prediction is not applied to the TU and there is at least one nonzero coefficient in the TU. If the first separate flag is 1, it indicates complementary prediction is used. When complementary prediction is used, a second separate flag is introduced to indicate whether there is any non-zero coefficient remaining after the complementary prediction.

In some embodiments, when complementary prediction is applied to a TU, all coefficients of the TU are set to be zero and the residual coefficient syntax is skipped for the TU. In some embodiments, TUs without using complementary prediction may be reconstructed first, followed by TUs using complementary prediction. Changing the processing order can provide better prediction because non-causal neighbors may be available for prediction. For example, as shown in FIG. 7C, the TUs 742 and 744 have CBF equals to 1, and all other TUs within the inter CU 740 have CBF equals to 0. All the TUs with CBF equals to 0 may be reconstructed first according to some embodiments. After reconstructing these TUs, the TUs 742 and 744 are surrounded by already reconstructed neighbors, which are available for motion vector prediction, spatial prediction and/or overlapped block motion compensation (OBMC).

In some embodiments, the spatial prediction mode or motion vector associated with the complementary prediction may be generated by using decoder-side motion vector derivation or decoder-side intra prediction derivation. In some embodiments, complementary prediction may be applied to TUs at TU depths larger than 0. In this case, the semantics of CBF are different at different TU depths. At TU depth equal to 0, the semantics of CBF are the same as the traditional CBF. At TU depths larger than 0, the CBF is set to 1 indicating complementary prediction may be applied.

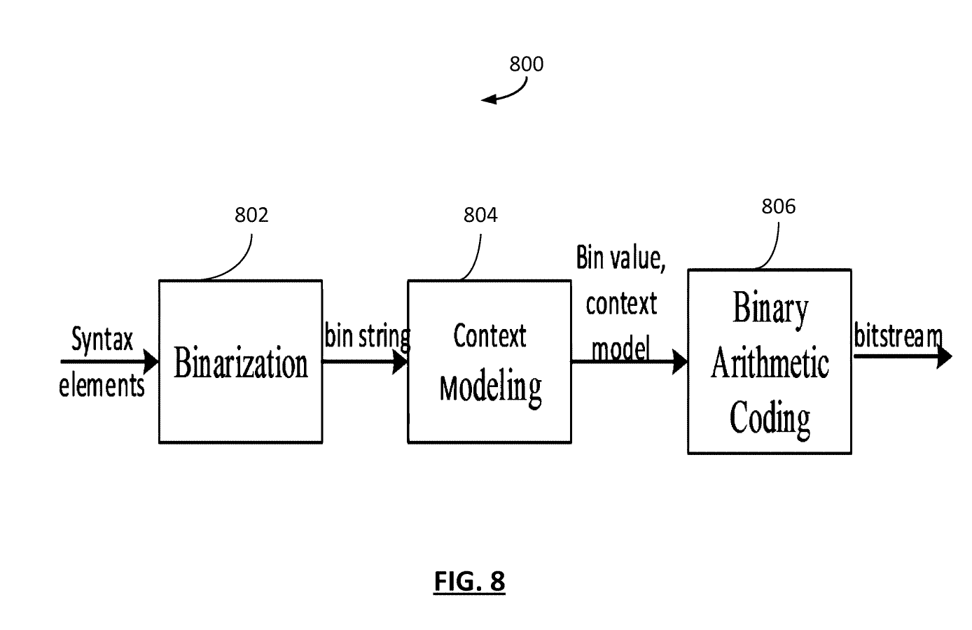

FIG. 8 is a flow 800 for encoding syntax elements that may implement the techniques described above. Flow 800 is performed by encoding system 200 (FIG. 2). In some embodiments, an encoding operation includes three operations: 1) a binarization operation 802; 2) a context modeling operation 804; 3) a binary arithmetic coding operation 806. In the first operation 802, a given nonbinary valued syntax element is uniquely mapped to a binary sequence, a so-called bin string. In a so-called regular coding mode, a bin may enter the context modeling operation 804 prior to the actual arithmetic coding operation 806, where a probability model is selected such that the corresponding choice may depend on previously encoded syntax elements or bins. Then after the selection of a context model, the bin value along with its associated model is passed to binary arithmetic coding operation 806. Suppose a pre-define set T of previously encoded bins, and a related set C={0, . . . , c−1} of contexts is given, where the contexts are specified by a modeling function F: T→C operating on the T. For each bin x to be coded, a conditional probability p(x, F(z)) is estimated by switching between different probability models according to the already coded bins zεT.

One benefit to arranging syntax elements into syntax planes is that the previous coded syntax planes are used to derive a better context model for the following syntax planes in some embodiments. For example, the CTB split flag plane provides some information on the degree of difficulty to compress the current CTB. If the number of quad-tree split levels is large and/or if many leaf nodes have small block sizes, a different context model from CTBs with little or no quad-tree split and/or with coding units using larger block sizes is used in some embodiments. There are several ways to estimate the difficulty to compress, alternatively referred to as activity measure. In some embodiments, the activity measure is represented as follows:

activity_measure=max_depth,

where max_depth is the maximum quad-tree split level of the CTB. The context model of syntax elements in the following syntax planes such as prediction mode can be selected based on the value of activity_measure. For example,

F(z)=activity_measure

For each value of activity_measure, there could be a separate probability model.

After each syntax plane is coded, the probability model is updated by feeding new coded bins in some embodiments. If multiple syntax planes are encoded, the context model for the bins of the following syntax plane(s) are selected based on the previously coded syntax planes jointly in some embodiments. In some embodiments, cross-syntax dependency is used.

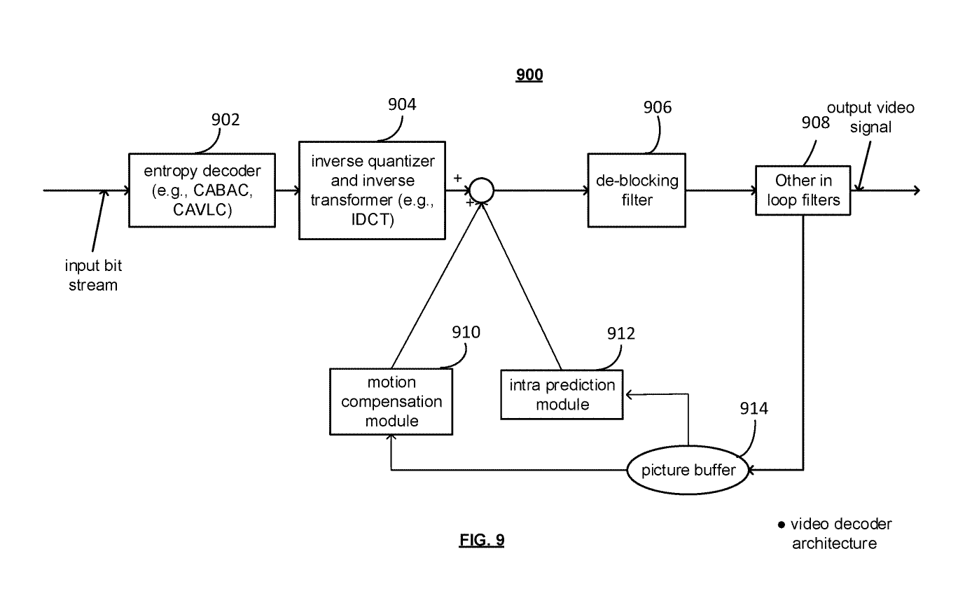

FIG. 9 is a block diagram of a video decoding system 900. The video decoding system 900 is configured to operate on an input encoded bitstream to generate an output decoded video. The video decoding system 900 may include an entropy decoder 902, an inverse quantizer and transformer 904, a de-blocking filter 906, in loop filters 908, a motion compensation module 910, an intra-prediction module 912 and a picture buffer 914.

In some embodiments, the entropy decoder 902 (e.g., which may be implemented in accordance with CABAC, CAVLC, etc.) may be configured to process the input bitstream in accordance with performing the complementary prediction of encoding as performed within a video encoder system. According to some embodiments, the input encoded bitstream may include a plurality of CUs. According to some embodiments, each CU may include a plurality of TUs. The TUs may be encoded by the encoder using different coding modes. According to some embodiments, each encoded TU may be associated with a coding mode information. Each coding mode may correspond to a prediction method. For example, a complementary coding mode may correspond to a complementary prediction. According to some embodiments, the input bitstream may include coding information indicating a coding mode for each TU. For example, for TU that undergoes complementary prediction, a complementary coding mode information may be included in the input bitstream. According to some embodiments, the entropy decoder 902 may be configured to receive the coding mode information associated with each TU. For example, the entropy decoder 902 may receive a CU with a first coding mode information associated with a first set of TUs of the CU and a second coding mode information associated with a second set of TUs of the CU. According to some embodiments, the entropy decoder 902 may be configured to use the first coding mode information and the second coding mode information to decode the CU. According to some embodiments, the entropy decoder 902 may be configured to use the first coding mode information to decode the first set of TUs, and user the second coding mode information to decode the second set of TUs. According to some embodiments, the entropy decoder 902 may be configured to decode the first set of TUs before decoding the second set of TUs. According to some embodiments, the entropy decoder 902 may be configured to decode TUs that are not associated with a complementary coding mode before decoding TUs that are associated with a complementary coding mode.

The entropy decoder 902 may be configured to process the input bitstream and extract appropriate coefficients from the input bitstream, such as the DCT coefficients and provides such coefficients to the inverse quantizer and transformer 904. In the event that a DCT transform is employed, the inverse quantizer and transformer 904 may be implemented to perform an inverse DCT (IDCT) operation. Subsequently, the inverse transform output is added into the output from the motion compensated module 910 (e.g., a motion compensated inter-prediction module) or the intra-prediction module 912 to form the reconstructed data. The de-blocking filter 906 and other loop filters 908 are applied to generate pictures corresponding to an output video signal. These pictures may be provided into a picture buffer 914, or a digital picture buffer (DPB) for use in performing other operations including motion compensated prediction 910. The output video signal can be provided to a display associated with communication device 120 (FIG. 1) in some embodiments.

Various modules and components described in FIG. 9 are implemented as a software routine operating on a computer processor, application specific circuit, digital signal processor, or other circuit in some embodiments. The picture buffer 914 may be any type of memory or storage unit.

The present invention has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The present invention may have also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contrary, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

While particular combinations of various functions and features of the present invention have been expressly described herein, other combinations of these features and functions are likewise possible. The present invention is not limited by the particular examples disclosed herein and expressly incorporates these other combinations.

What is claimed is:

1. A method of processing video information, comprising:
providing a plurality of processing units uniformly for a frame, each of the plurality of processing units associated with one or more encoding parameters;
grouping the plurality of processing units into one or more processing planes based on a corresponding one or more of the encoding parameters, each of the one or more processing planes associated with at least one type of the encoding parameters;
encoding each of the one or more processing planes based on the corresponding one or more of the encoding parameters;
transmitting each of the one or more encoded processing planes.

2. The method of claim 1, wherein the encoding parameters comprise quantized transform coefficients, intra-prediction information, inter-prediction information, structure information of compressed data, compression tools for encoding, and video sequence information.

3. The method of claim 1, wherein the processing planes comprise a split flag plane, prediction mode plane, partitioning mode plane, reference index plane, motion vector plane, spatial prediction direction plane, quantization parameter plane, coded block flag plane, and coefficient plane.

4. The method of claim 1, further comprising:
determining, for each of the processing units, whether to split the processing unit into multiple coding units;
responsive to determining splitting a first processing unit into multiple coding units, splitting the first processing unit into a plurality of coding units;
determining, for each of the coding units, whether to split the coding unit into multiple transform units;
responsive to determining splitting a first coding unit into multiple transform units, splitting the first coding unit into multiple transform units;
encoding a first set of transform units using a first coding mode;
encoding a second set of transform units using a second coding mode.

5. The method of claim 4, wherein the plurality of coding units comprise a plurality of intra coded units and a plurality of inter coded units.

6. The method of claim 5, further comprising encoding the plurality of inter coded units before encoding the plurality of intra coded units.

7. The method of claim 1, further comprising encoding one or more of the processing planes based at least in part on one or more previously encoded processing planes.

8. An encoder for encoding a plurality of macroblocks organized into syntax planes, the encoder comprising:
an inra/inter mode selector configured to select an interprediction operation for one or more syntax planes and configured to select an intraprediction operation for other syntax planes of the syntax planes, wherein the other syntax planes are encoded in response to the one or more syntax planes encoded by the interprediction operation.

9. The encoder of claim 8, further comprising a transformer and quantizer configured to provide encoding parameters, wherein the encoding parameters comprise quantized transform coefficients, intra-prediction information, inter-prediction information, structure information of compressed data, compression tools for encoding, and video sequence information.

10. The encoder of claim 8, wherein the syntax planes comprise a split flag plane, prediction mode plane, partitioning mode plane, reference index plane, motion vector plane, spatial prediction direction plane, quantization parameter plane, coded block flag plane, and coefficient plane.

11. The encoder of claim 9, further comprising an entropy encoder processing the encoding parameters.

12. The encoder of claim 8, wherein encoding the one or more syntax planes are encoded before encoding the other syntax planes.

13. The encoder of claim 8, further comprising a motion estimation circuit.

14. A method of encoding syntax elements for a video signal, the method comprising:
selecting an interprediction operation for one or more syntax elements; and
selecting an intraprediction operation for other syntax elements of the plurality of syntax elements, wherein the other syntax elements are encoded in response to the one or more syntax elements encoded by the interprediction operation.

15. The method of claim 14, further comprising: providing encoding parameters, wherein the encoding parameters comprise quantized transform coefficients, intra-prediction information, inter-prediction information, structure information of compressed data, compression tools for encoding, and video sequence information.

16. The method of claim 14, wherein the syntax elements are organized into one or more syntax planes, the one or more syntax planes comprising a split flag plane, prediction mode plane, partitioning mode plane, reference index plane, motion vector plane, spatial prediction direction plane, quantization parameter plane, coded block flag plane, and coefficient plane.

17. The method of claim 16, wherein each of the one or more syntax planes is encoded based on one or more previous encoded syntax planes.

18. The method of claim 15, further comprising generating an output video signal using the encoding parameters.

19. The method of claim 14, further comprising:
performing interprediction operation for the one or more syntax elements at a first time; and
performing intraprediciton operation for the other syntax elements at a second time, wherein the first time is before the second time.

20. The method of claim 18, further comprising: transmitting the output video to one or more communication devices, wherein the communication device comprises a decoder.
